(19) United States
(12) Patent Application Publication
(10) Pub. No.: US 2021/0118112 A1
(43) Pub. Date: Apr. 22, 2021

(54) IMAGE PROCESSING METHOD AND DEVICE, AND STORAGE MEDIUM

(71) Applicant: BEIJING SENSETIME TECHNOLOGY DEVELOPMENT CO., LTD., Beijing (CN)

(72) Inventors: Mingyang HUANG, Beijing (CN); Changxu ZHANG, Beijing (CN); Chunxiao LIU, Beijing (CN); Jianping SHI, Beijing (CN)

(21) Appl. No.: 17/137,529

(22) Filed: Dec. 30, 2020

Related U.S. Application Data
(63) Continuation of application No. PCT/CN2019/130459, filed on Dec. 31, 2019.

(30) Foreign Application Priority Data
Aug. 22, 2019 (CN) 201910778128.3

(51) Int. Cl. G06T 5/50; G06T 7/11; G06T 7/194; G06T 3/40; G06T 5/00; G06N 20/00

(52) U.S. Cl. CPC G06T 5/50; G06T 7/11; G06T 7/194; G06T 3/40; G06T 2207/20081; G06N 20/00; G06T 2207/20221; G06T 2207/20192; G06T 2207/20084; G06T 5/002

(57) ABSTRACT

The present disclosure relates to an image processing method and device, and a storage medium. The method comprises generating at least one first partial image block according to a first image and at least one first semantic segmentation mask, generating a background image block according to the first image and a second semantic segmentation mask; fusing the at least one first partial image block and the background image block to obtain a target image. According to the image processing method of the embodiments of the present disclosure, it is possible to generate a target image according to the contour and location of the target object shown by the first semantic segmentation mask, the contour and location of the background area shown by the second semantic segmentation mask, and the first image having the target style.

### CROSS-REFERENCE TO RELATED APPLICATION

The present disclosure is a continuation of and claims priority under 35 U.S.C. § 120 to PCT Application. No. PCT/CN2019/130459, filed on Dec. 31, 2019, which is based upon and claims the benefit of a priority of Chinese Patent Application No. 201910778128.3, filed on Aug. 22, 2019 and titled “Image Processing Method and Device, Electronic Apparatus and Storage Medium”. All the above referenced priority documents are incorporated herein by reference.

### TECHNICAL FIELD

The present disclosure relates to the technical field of computer, in particular to an image processing method and device, electronic apparatus and storage medium.

### BACKGROUND

In the related art, during image generation, it is possible to transform the style of the original image though a neural network to generate an image having a new style. Usually, to train a neural network for style transformation, two sets of images with the same image contents but different styles are required. Such two sets of images are very difficult to collect.

### SUMMARY

The present disclosure proposes an image processing method and device, an electronic apparatus and a storage medium.

According to one aspect of the present disclosure, provided is an image processing method, comprising:

generating at least one first partial image block according to a first image and at least one first semantic segmentation mask, wherein the first image is an image having a target style, the first semantic segmentation mask is a semantic segmentation mask showing an area in which a target object of one type is located, the first partial image block includes the target object of one type having the target style;

generating a background image block according to the first image and a second semantic segmentation mask, wherein the second semantic segmentation mask is a semantic segmentation mask showing a background area other than the area in which at least one target object is located, the background image block includes a background having the target style;

and

fusing the at least one first partial image block and the background image block to obtain a target image, wherein the target image includes the target object having the target style and the background having the target style.

According to the image processing method of the embodiments of the present disclosure, it is possible to generate a target image according to the contour and location of the target object shown by the first semantic segmentation mask, the contour and location of the background area shown by the second semantic segmentation mask, and the first image having the target style, it is possible to only collect the first image, saving the need to collect two sets of images having the same image content but different styles, thereby reducing the difficulty of image collection. In addition, the first image may be reused for generating an image of a target object having a random contour and position, thereby reducing the cost of image generation.

In a possible implementation, fusing the at least one first partial image block and the background image block to obtain the target image comprises:

scaling each of the first partial image block to obtain a second partial image block having a matching size when splicing with the background image block; and

splicing at least one second partial image block and the background image block to obtain the target image.

In a possible implementation, the background image block is an image that the background area includes a background having the target style and an area in which the target object is located is vacant,

splicing the at least one second partial image block and the background image block to obtain the target image comprises:

adding the at least one second partial image block to a corresponding area in which the target object is located in the background image block to obtain the target image.

In this manner, it is possible to generate a target image having a target style using the first semantic segmentation mask, the second semantic segmentation mask and the first image. A corresponding second partial image block may be generated for the first semantic segmentation mask of each target object, thereby diversifying the target object generated. Moreover, since the second partial image block is generated according to the first semantic segmentation mask and the first image, there is no need to use a neural network for style transformation to generate an image having a new style, saving the need of supervising and training the neural network for style transformation using a large number of samples, and thus saving the need of marking the large number of samples, thereby improving the image processing efficiency.

In a possible implementation, after splicing the at least one second partial image block and the background image block and before obtaining the target image, the method further comprises:

smoothing an edge between the at least one second partial image block and the background image block to obtain a second image; and

fusing styles of the area in which the target object is located and the background area in the second image to obtain the target image.

In this manner, it is possible to smooth the edge between the area in which the target object is located and the background area, and fuse the styles of the images, so that the target image generated is natural and harmonious and achieves higher authenticity.

In a possible implementation, the method further comprises:

performing a semantic segmentation on an image to be processed to obtain the first semantic segmentation mask and the second semantic segmentation mask.

In a possible implementation, generating the at least one first partial image block according to the first image and the at least one first semantic segmentation mask and generating the background image block according to the first image and the second semantic segmentation mask are performed by an image generation network.

The image generation network is trained using steps of:

generating an image block according to a first sample image and a semantic segmentation sample mask by an image generation network to be trained,

wherein, the first sample image is a sample image having a random style, the semantic segmentation sample mask is a semantic segmentation sample mask showing an area in which the target object is located in a second sample image or is a semantic segmentation sample mask showing an area other than the area in which the target object is located in the second sample image, when the semantic segmentation sample mask is the semantic segmentation sample mask showing an area in which the target object is located in the second sample image, the generated image block includes a target object having the target style, and when the semantic segmentation sample mask is the semantic segmentation sample mask showing an area other than the area in which the target object is located in the second sample image, the generated image block includes a background having the target style;

determining a loss function of the image generation network to be trained according to the generated image block, the first sample image and the second sample image;

adjusting a network parameter value of the image generation network to be trained according to the determined loss function;

identifying authenticity of a portion to be identified in the input image by an image discriminator to be trained by using the generated image block or the second sample image as an input image, wherein, when the generated image block includes the target object having the target style, the portion to be identified in the input image is the target object in the input image, and when the generated image block includes the background having the target style, the portion to be identified in the input image is the background in the input image;

adjusting the network parameter value of the image discriminator to be trained and the network parameter value of the image generation network to be trained according to an output result of the image discriminator to be trained and the input image; and

repeatedly executing the above steps by using the image generation network of which the network parameter value is adjusted as the image generation network to be trained and using the image discriminator of which the network parameter value is adjusted as the image discriminator to be trained, until a training termination condition of the image generation network to be trained and a training termination condition of the image discriminator to be trained reach a balance.

In this manner, it is possible to train the image generation network using any semantic segmentation mask and a sample image of any style. The semantic segmentation mask and the sample image both have reusability. For example, the same set of semantic segmentation mask and different sample images may be used to train different image generation networks, or, the image generation network may be trained by the same sample image and semantic segmentation mask. There is no need to mark a large number of actual images to obtain the training samples, saving the marking cost. Moreover, the image generated by the trained image generation network has the style of the sample image, saving the need of re-training for generating images containing other contents, thereby improving the processing efficiency.

According to another aspect of the present disclosure, provided is an image processing device, comprising:

a first generation module configured to generate at least one first partial image block according to a first image and at least one first semantic segmentation mask, wherein the first image is an image having a target style, the first semantic segmentation mask is a semantic segmentation mask showing an area in which a target object of one type is located, the first partial image block includes the target object of one type having the target style;

a second generation module configured to generate a background image block according to the first image and a second semantic segmentation mask, wherein the second semantic segmentation mask is a semantic segmentation mask showing a background area other than the area in which at least one target object is located, the background image block includes a background having the target style; and

a fusion module configured to fuse the at least one first partial image block and the background image block to obtain a target image, wherein the target image includes the target object having the target style and the background having the target style.

In a possible implementation, the fusion module is configured further to scale each first partial image block to obtain a second partial image block having a matching size when splicing with the background image block; and

splice the at least one second partial image block and the background image block to obtain the target image.

In a possible implementation, the background image block is an image that the background area includes a background having the target style and an area in which the target object is located is vacant,

wherein the fusion module is configured further to splice the at least one second partial image block and the background image block to obtain the target image comprises:

adding the at least one second partial image block to a corresponding area in which the target object is located in the background image block to obtain the target image.

In a possible implementation, the fusion module is configured further to after splicing the at least one second partial image block and the background image block and before obtaining the target image, smooth an edge between the at least one second partial image block and the background image block to obtain a second image; and

fuse styles of the area in which the target object is located and the background area in the second image to obtain the target image.

In a possible implementation, the device further comprises:

a segmentation module configured to perform a semantic segmentation on an image to be processed to obtain the first semantic segmentation mask and the second semantic segmentation mask.

In a possible implementation, functions of the first generation module and the second generation module are performed by an image generation network;

The device further comprises a training module, the training module configured to train the image generation network using steps of:

generating an image block according to a first sample image and a semantic segmentation sample mask by an image generation network to be trained,

wherein, the first sample image is a sample image having a random style, the semantic segmentation sample mask is a semantic segmentation sample mask showing an area in which the target object is located in the second sample image or is a semantic segmentation sample mask showing an area other than the area in which the target object is located in the second sample image, when the semantic segmentation sample mask is the semantic segmentation sample mask showing an area in which the target object is located in the second sample image, the generated image block includes a target object having the target style, when the semantic segmentation sample mask is the semantic segmentation sample mask showing an area other than the area in which the target object is located in the second sample image, the generated image block includes a background having the target style;

determining a loss function of the image generation network to be trained according to the generated image block, the first sample image and the second sample image;

adjusting a network parameter value of the image generation network to be trained according to the determined loss function;

identifying authenticity of a portion to be identified in a input image by an image discriminator to be trained by using the generated image block or the second sample image as the input image, wherein, when the generated image block includes the target object having the target style, the portion to be identified in the input image is the target object in the input image, and when the generated image block includes the background having the target style, the portion to be identified in the input image is the background in the input image;

adjusting the network parameter value of the image discriminator to be trained and the network parameter value of the image generation network to be trained according to an output result of the image discriminator to be trained and the input image; and

repeatedly executing the above steps by using the image generation network of which the network parameter value is adjusted as an image generation network to be trained and using the image discriminator of which the network parameter value is adjusted as the image discriminator to be trained, until a training termination condition of the image generation network to be trained and a training termination condition of the image discriminator to be trained reach a balance.

According to another aspect of the present disclosure, provided is an electronic apparatus, comprising:

a processor,

a memory configured to store processor executable instructions,

wherein the processor is configured to call instructions stored in the memory to execute the afore-described image processing method.

According to another aspect of the present disclosure, provided is a computer readable storage medium that stores computer program instructions, wherein the computer program instructions realize the afore-described image processing method.

According to another aspect of the present disclosure, provided is a computer program, wherein the computer program includes computer readable codes, and when the computer readable codes run in an electronic apparatus, a processor of the electronic apparatus executes the afore-described image processing method.

It is appreciated that the foregoing general description and the subsequent detailed description are merely exemplary and illustrative and do not limit the present disclosure.

Additional features and aspects of the present disclosure will become apparent from the following description of exemplary examples with reference to the attached drawings.

### BRIEF DESCRIPTION OF THE DRAWINGS

The drawings, which are incorporated in and constitute part of the specification, together with the description, illustrate embodiments of the present disclosure and serve to explain the technical solution of the present disclosure.

FIG. 1 is a flow chart of the image processing method according to an embodiment of the present disclosure.

FIG. 2 is a schematic diagram of the first semantic segmentation mask according to an embodiment of the present disclosure.

FIG. 3 is a schematic diagram of the second semantic segmentation mask according to an embodiment of the present disclosure.

FIG. 4 is a flow chart of the image processing method according to an embodiment of the present disclosure.

FIG. 5 is an application schematic diagram of the image processing method according to an embodiment of the present disclosure.

FIG. 6 is a block diagram of the image processing device according to an embodiment of the present disclosure.

FIG. 7 is a block diagram of the image processing device according to an embodiment of the present disclosure.

FIG. 8 is a block diagram of the electronic apparatus according to an embodiment of the present disclosure.

FIG. 9 is a block diagram of the electronic apparatus according to an embodiment of the present disclosure.

### DETAILED DESCRIPTION

Various exemplary examples, features and aspects of the present disclosure will be described in detail with reference to the drawings. The same reference numerals in the drawings represent parts having the same or similar functions. Although various aspects of the examples are shown in the drawings, it is unnecessary to proportionally draw the drawings unless otherwise specified.

Herein the term “exemplary” means “used as an instance or example, or explanatory”. An “exemplary” example given here is not necessarily construed as being superior to or better than other examples.

Herein the term “and/or” describes a relation between associated objects and indicates three possible relations. For example, the phrase “A and/or B” indicates a case where only A is present, a case where A and B are both present, and a case where only B is present. In addition, the term “at least one” herein indicates any one of a plurality or a random combination of at least two of a plurality. For example, including at least one of A, B and C means including any one or more elements selected from a group consisting of A, B and C.

Numerous details are given in the following examples for the purpose of better explaining the present disclosure. It should be understood by a person skilled in the art that the present disclosure can still be realized even without some of those details. In some of the examples, methods, means, units and circuits that are well known to a person skilled in the art are not described in detail so that the principle of the present disclosure become apparent.

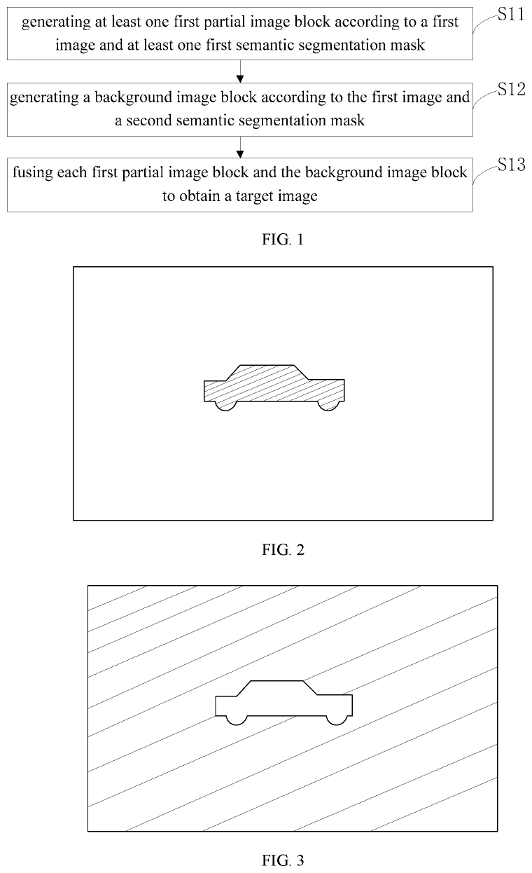

FIG. 1 is a flow chart of the image processing method according to an embodiment of the present disclosure. As shown in FIG. 1, the method comprises:

step S11 of generating at least one first partial image block according to a first image and at least one first semantic segmentation mask, wherein the first image is an image having a target style, the first semantic segmentation mask is a semantic segmentation mask showing an area in which a target object of one type is located, the first partial image block includes a target object of one type having the target style,

step S12 of generating a background image block according to the first image and a second semantic segmentation mask, wherein the second semantic segmentation mask is a semantic segmentation mask showing a background area other than the area in which at least one target object is located, the background image block includes a background having the target style,

step S13 of fusing at least one first partial image block and the background image block to obtain a target image, wherein the target image includes a target object having the target style and a background having the target style.

According to the image processing method of the embodiments of the present disclosure, it is possible to generate a target image according to the contour and location of the target object shown by the first semantic segmentation mask, the contour and location of the background area shown by the second semantic segmentation mask, and the first image having the target style, it is possible to only collect the first image, without collect two sets of images having the same image content but different styles, thereby reducing the difficulty of image collection. In addition, the first image is reusable for image generation for a target object having a random contour and location, thereby saving the cost for image generation.

The execution subject of the image processing method may be an image processing device. For example, the image processing method may be executed by a terminal device or a server or other processing device, wherein the terminal device may be a user equipment (UE), a mobile device, a user terminal, a terminal, a cellular phone, a cordless phone, a personal digital assistant (PDA), a handheld device, a computing device, an in-vehicle device, a wearable device, etc. In some possible implementations, the image processing method may be implemented by a processor calling computer readable instruction stored in a memory.

In a possible implementation, the first image is an image including at least one target object, and the first image has the target style. A style of image includes brightness, contrast ratio, illumination, color, artistic characteristics or graphic design, etc in the image. In an example, the first image may be an RGB image captured in an environment of daytime, nighttime, rain, fog, etc, and the first image includes at least one target object such as motor vehicle, non-motor vehicle, person, traffic sign, traffic light, tree, animal, building, obstacle, etc. In the first image, an area other than the area in which the target object is located is the background area.

In a possible implementation, the first semantic segmentation mask is a semantic segmentation mask marking the area in which the target object is located. For example, in an image including multiple target objects such as vehicle, person, and/or non-motor vehicle, etc., the first semantic segmentation mask may be a segmentation coefficient map (e.g., binary segmentation coefficient map) marking the position of the area in which the target object is located. For example, in the area in which the target object is located, the segmentation coefficient is 1; in the background area, the segmentation coefficient is 0; the first semantic segmentation mask may indicate the contour of the target object (e.g., vehicle, person, obstacle, etc.).

FIG. 2 is a schematic diagram of the first semantic segmentation mask according to an embodiment of the present disclosure. As shown in FIG. 2, the image includes a vehicle; the first semantic segmentation mask of the image is a segmentation coefficient map marking the position of the area in which the vehicle is located. In other words, in the area in which the vehicle is located, the segmentation coefficient is 1 (shown by the shadow in FIG. 2); in the background area, the segmentation coefficient is 0.

In a possible implementation, the second semantic segmentation mask is a semantic segmentation mask marking the background area other than the area in which the target object is located. For example, in an image including multiple target objects such as vehicle, person, and/or non-motor vehicle, etc., the second semantic segmentation mask may be a segmentation coefficient map (e.g., binary segmentation coefficient map) marking the position of the background area. For example, in the area in which the target object is located, the segmentation coefficient is 0; in the background area, the segmentation coefficient is 1.

FIG. 3 is a schematic diagram of the second semantic segmentation mask according to an embodiment of the present disclosure. As shown in FIG. 3, an image includes a vehicle. The second semantic segmentation mask for the image is a segmentation coefficient map making the position of the background area other than the area in which the vehicle is located. In other words, in the area in which the vehicle is located, the segmentation coefficient is 0; in the background area, the segmentation coefficient is 1 (indicated by the shadow in FIG. 3).

In a possible implementation, a first semantic segmentation mask and a second semantic segmentation mask may be obtained according to the image to be processed including the target object.

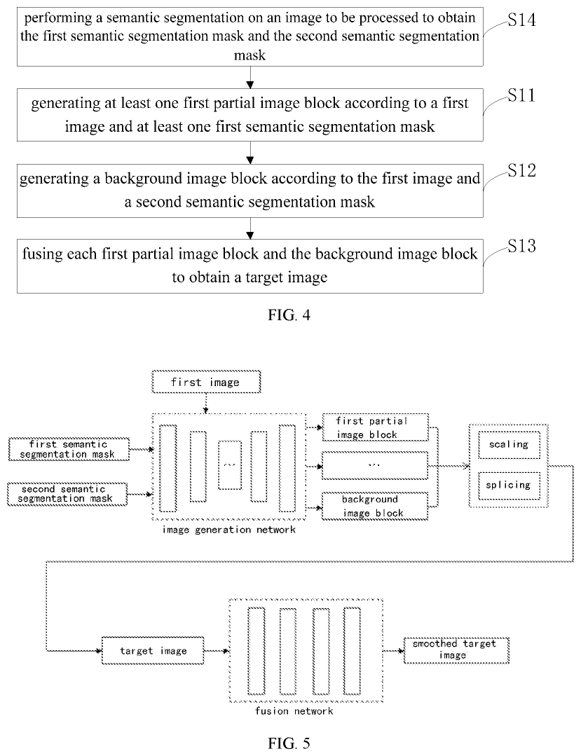

FIG. 4 is a flow chart of the image processing method according to an embodiment of the present disclosure. As shown in FIG. 4, the method further comprises:

Step S14 of performing a semantic segmentation on an image to be processed to obtain the first semantic segmentation mask and the second semantic segmentation mask.

In a possible implementation, in the step S14, the image to be processed may be any image including any target object. The first semantic segmentation mask and the second semantic segmentation mask of the image to be processed can be obtained by marking the image to be processed. Alternatively, a semantic segmentation network may be used to perform a semantic segmentation on the image to be processed to obtain the first semantic segmentation mask and the second semantic segmentation mask of the image to be processed. The present disclosure does not limit the method of semantic segmentation.

In a possible implementation, the first semantic segmentation mask and the second semantic segmentation mask may be semantic segmentation masks generated randomly. For example, it is possible to randomly generate the first semantic segmentation mask and the second semantic segmentation mask by an image generation network, without performing semantic segmentation on a specific image. The present disclosure does not limit the method for obtaining the first semantic segmentation mask and the second semantic segmentation mask.

In a possible implementation, in the step S11, it is possible to obtain the first partial image block by the image generation network according to the first image having the target style and the at least one first semantic segmentation mask. The first semantic segmentation mask may be semantic segmentation masks of various target objects. For example, the target object may be pedestrian, motor-vehicle, non-motor vehicle, etc. The first semantic segmentation mask may indicate the contour of the target object. The image generation network may include a deep learning neural network such as convolution neural network. The present disclosure does not limit the type of image generation network. In an example, the first partial image block includes the target object having the target style. For example, the first partial image block generated may be at least one of an image block of pedestrian, an image block of motor vehicle, an image block of non-motor vehicle or an image block of other object which has the target style.

In a possible implementation, the first partial image block may also be generated according to the first image and the first semantic segmentation mask. For example, in the area in which the target object is located in the second semantic segmentation mask, the segmentation coefficient is 0; in the background area, the segmentation coefficient is 1. Hence, the second semantic segmentation mask can reflect the positional relationship of the at least one target object in the image to be processed. According to different positional relationships, the style may vary. For example, the target objects may block each other and form shadows. Or, due to different positional relationships, the lamination conditions may vary. Therefore, due to different positional relationships, the partial image block generated according to the first image, the first semantic segmentation mask and the second semantic segmentation mask may not have exactly the same style.

In an example, the first semantic segmentation mask is a semantic segmentation mask making the area in which the target object (e.g., vehicle) is located in the image to be processed. The image generation network may generate an RGB image block having the contour of the target object marked by the first semantic segmentation mask and having the target style of the first image, i.e., a first partial image block.

In a possible implementation, in the step S12, the background image block may be generated according to the second semantic segmentation mask and the first image having the target style by an image generation network. In other words, the background image block may be obtained by inputting the second semantic segmentation mask and the first image into the image generation network.

In an example, the second semantic segmentation mask is a semantic segmentation mask marking the background area in the image to be processed. The image generation network may generate an RGB image block having the contour of the background marked by the second semantic segmentation mask and having the target style of the first image, i.e., a background image block. The background image block is an image that the background area includes a background having the target style and the area in which the target object is located is vacant.

In a possible implementation, in the step S13, fusing at least one first partial image block and the background image block to obtain a target image. The step S13 may include: scaling each first partial image block to obtain a second partial image block having a matching size when splicing with the background image block, splicing at least one second partial image block and the background image block to obtain the target image.

In a possible implementation, the first partial image block is an image block having the contour of the target object generated according to the contour of the target object in the first semantic segmentation mask and the target style of the first image. However, during the generation, the size of the contour of the target object may alter. Therefore, the first partial image block may be scaled to obtain a second partial image block having a size corresponding with the size of the background image block. For example, the size of the second partial image block may be matching with the size of the area in which the target object is located (i.e., the vacant area) in the background image block.

In a possible implementation, the second partial image block and the background image block may be spliced. This step may include: adding at least one second partial image block to a corresponding area in which the target object is located in the background image block to obtain the target image. The area in which the target object is located in the target image is the second partial image block. The background area in the target image is the background image block. For example, the second partial image block of the target object of person, motor vehicle, non-motor vehicle may be added to a corresponding position in the background image block. The area in which the target object is located and the background area in the target image both have the target style. But the edge between the areas of the target image formed by splicing may be not smooth enough.

In this manner, it is possible to generate a target image having a target style using the first semantic segmentation mask, the second semantic segmentation mask and the first image. A corresponding second partial image block may be generated for the first semantic segmentation mask of each target object, thereby diversifying the target object generated. Moreover, since the second partial image block is generated according to the first semantic segmentation mask and the first image, there is no need to use a neural network for style transformation to generate an image having a new style, saving the need of supervising and training the neural network for style transformation using a large number of samples, and thus saving the need of marking the large number of samples, thereby improving the image processing efficiency.

In a possible implementation, since the edge between the area in which the target object is located and the background area in the spliced target image is formed by splicing, it may be not smooth enough. Therefore, after splicing the at least one second partial image block and the background image block and before obtaining the target image, smoothing can be performed to obtain the target image.

In a possible implementation, after splicing the at least one second partial image block and the background image block and before obtaining the target image, the method further comprises: smoothing an edge between the at least one second partial image block and the background image block to obtain the second image; fusing styles of an area in which the target object is located and a background area in the second image to obtain the target image.

In a possible implementation, the target object and the background in the second image may be fused by a fusion network to obtain the target image.

In a possible implementation, fusion of the area in which the target object is located and the background area may be fused by a fusion network. The fusion network may be a deep learning neural network such as convolution neural network. The present disclosure does not limit the type of the fusion network. In an example, the fusion network may determine the position of the edge between the area in which the target object is located and the background area or determine the position of the edge directly based on the position of the vacant area in the background image block, and performs smoothing on the pixels in the vicinity of the edge, for example, perform smoothing by Gaussian filter on the pixels in the vicinity of the edge, thereby obtaining the second image. The present disclosure does not limit the smoothing method.

In a possible implementation, the fusion network may be used to perform style fusion on the second image. For example, the style including brightness, contrast ratio, illumination, color, artistic characteristics or graphic design, etc. of the area in which the target object is located and the background area in the second image may be slightly adjusted such that the area in which the target object is located and the background area have consistent and harmonious styles, thereby obtaining the target image. The present disclosure does not limit the method for style fusion.

In a further example, in backgrounds of the same style, different target objects may have slightly varied styles. For example, in a background of nighttime, the target objects, as locating in different positions and having different illumination, the styles may vary slightly. Style fusion may be performed based on the position of the target object in the target image and the style of the background area in the vicinity of the position of the target object to adjust slightly the style of each target object, so that the area in which each target object is located and the background area have more harmonious styles.

In this manner, it is possible to smooth the edge between the area in which the target object is located and the background area, and fuse the styles of the images, so that the target image generated is natural and harmonious and achieves higher authenticity.

In a possible implementation, before generating the target image by the image generation network and the fusion network, the image generation network and the fusion network may be trained. For example, the image generation network and the fusion network may be trained using a generative adversarial training method.

In a possible implementation, generating the at least one first partial image block according to the first image and the at least one first semantic segmentation mask and generating the background image block according to the first image and the second semantic segmentation mask are performed by an image generation network, the image generation network trained using steps of:

generating an image block according to a first sample image and a semantic segmentation sample mask by an image generation network to be trained, wherein the first sample image is a sample image having a random style, the semantic segmentation sample mask is a semantic segmentation mask showing an area in which the target object is located in the second sample image or is a semantic segmentation mask showing an area other than the area in which the target object is located in the second sample image, when the semantic segmentation sample mask is a semantic segmentation sample mask showing an area in which the target object is located in the second sample image, the image block generated includes a target object having the target style, when the semantic sample segmentation mask is a semantic sample segmentation mask showing an area other than the area in which the target object is located in the second sample image, the image block generated includes a background having the target style.

determining a loss function of the image generation network to be trained according to the image block generated, the first sample image and the second sample image, adjusting a network parameter value of the image generation network to be trained according to the loss function determined, identifying authenticity of a portion to be identified in an input image by an image discriminator to be trained by using the image block generated or the second sample image as the input image, wherein, when the image block generated includes a target object having the target style, the portion to be identified in the input image is the target object in the input image, when the image block generated includes a background having the target style, the portion to be identified in the input image is the background in the input image, adjusting the network parameter value of the image discriminator to be trained and the network parameter value of the image generation network according to the output result of the image discriminator to be trained and the input image, repeatedly executing the above steps by using the image generation network of which the network parameter value is adjusted as an image generation network to be trained and using the image discriminator of which the network parameter value is adjusted as the image discriminator to be trained, until a training termination condition of the image generation network to be trained and a training termination condition of the image discriminator to be trained reach a balance.

For example, when the semantic segmentation sample mask is a semantic segmentation sample mask showing the area in which the target object is located in the second sample image, the image generation network may generate an image block of the target object having the target style. The image discriminator may identify the authenticity of the image block of the target object having the target style in an input image, and adjust the network parameter value of the image discriminator to be trained and the network parameter value of the image generation network to be trained according to the output result of the image discriminator to be trained, the generated image block of the target object having the target style and the image block of the target object in the second sample image. When the semantic segmentation sample mask is a semantic segmentation sample mask showing an area other than the area in which the target object is located in the second sample image, the image generation network may generate the background image block having the target style. The image discriminator may identify the authenticity of the background image block having the target style in the input image, and adjust the network parameter value of the image discriminator to be trained and the network parameter value of the image generation network to be trained according to the output result of the image discriminator to be trained, the generated background image block having the target style and the background image block in the second sample image.

For a further example, if the semantic segmentation sample mask includes both a semantic segmentation sample mask showing the area in which the target object is located in the second sample image and a semantic sample segmentation mask showing the area other than the area in which the target object is located in the second sample image, the image generation network may generate an image block of the target object having the target style and a background image block having the target style. Thence, the image block of the target object having the target style and the background image block having the target style are fused to obtain a target image, wherein the fusion process may be performed by a fusion network. Subsequently, the image discriminator may identify the authenticity of the input image (the input image is the obtained target image or second sample image) and adjust the network parameter values of the image discriminator to be trained, the image generation network and the fusion network according to the output result of the image discriminator to be trained, the target image obtained and the second sample image. In an example, the loss function of the image generation network to be trained is determined according to the image block generated, the first sample image and the second sample image. For example, according to the difference in style between the image block and the first sample image and the difference in content between the image block and the second sample image, the network loss of the image generation network is determined.

In an example, the generated image block or the second sample image may be used as the input image. The image discriminator to be trained is used to identify the authenticity of the portion to be identified in the input image. The output result of the image discriminator is the probability of the input image being a true image. When the image block generated includes a target object having the target style, the portion to be identified in the input image is the target object in the input image; when the image block generated includes a background having the target style, the portion to be identified in the input image is the background in the input image.

In an example, according to the network loss of the image generation network and the output result of the image discriminator, adversarial training may be performed for the image generation network and the image discriminator. For example, the network parameters of image generation network and the image discriminator may be adjusted according to the network loss of the image generation network and the output result of the image discriminator. The training process may be iterated till a first training condition and a second training condition reach a balance. The first training condition may be, for example, when the network loss of the image generation network reaches a minimum or is below a preset threshold value. The second training condition may be, for example, when the output result of the image discriminator indicates that the probability of actual image reaches a maximum or exceeds a preset threshold value. In such case, the image block generated by the image generation network has a higher authenticity, i.e. the image generated by the image generation network has a good effect. Moreover, the image discriminator has relatively high accuracy. The image generation network of which the network parameter value is adjusted is used as an image generation network to be trained, and the image discriminator of which the network parameter value is adjusted is used as the image discriminator to be trained.

In a possible implementation, the target object and the background in the image block are spliced to be input into the fusion network to output the target image.

In an example, the network loss of the fusion network may be determined according to a difference between the contents of the target image and the second sample image and a difference between the styles of the target image and the second sample image. Moreover, the network parameter of the fusion network may be adjusted according to the network loss of the fusion network. The adjustment of the fusion network may be iterated till the network loss of the fusion network is less than or equal to a loss threshold value or is converged within a preset range or the number of times of adjustment reaches a threshold value, thereby obtaining the trained fusion network. In such case, the target image output by the fusion network has a higher authenticity. That is, the image output by the fusion network has an edge well smoothed and a harmonious overall style.

In an example, the fusion network and the image generation network and the image discriminator may be trained together. In other words, the image block of the target object having the target style and the background image block generated by the image generation network may be spliced to be processed by the fusion network to generate the target image. The target image or the second sample image is input into the image discriminator as the input image to be identified its authenticity. The network parameter values of the discriminator, the image generation network and the fusion network to be trained are adjusted by means of the target image output by the image discriminator and the second sample image till the training conditions afore-mentioned are satisfied.

In the related art, when style transformation is performed on an image, a neural network for style transformation is used to process a raw image to generate an image having a new style. The neural network for style transformation needs to be trained using a large number of sample images having a specific style. The cost for acquiring the sample images is relatively high (e.g., when the style is severe weather, acquiring the sample images in severe weather could be very difficult and expansive). Moreover, the trained neural network can only generate images of this style and transform the input images to have the same style. If a different style is desired, the neural network will need to be trained again using a large number of sample images. Hence, the sample images are not used at high efficiency, and the style transformation is performed with great difficulty and low efficiency.

According to the image processing method of the embodiments of the present disclosure, a corresponding first partial image block may be generated for the first semantic segmentation mask of each target object according to the first semantic segmentation mask, the second semantic segmentation mask, the second partial image block and the background image block having the target style. Since it is relatively easy to acquire the first semantic segmentation mask, multiple types of first semantic segmentation mask may be acquired such that the generated target object is diversified without the need to mark a large number of actual images, saving the cost for marking and improving the processing efficiency. Further, it is possible to smooth the edge between the area in which the target object is located and the background area, and fuse the styles of the images, so that the generated target image is natural and harmonious and has a higher authenticity while having the style of the first image. During image generation, it is possible to replace the first image, for example, with a first image of a different style. Thence, the generated target image has the style of the first image after the replacement. This saves the need to retrain the neural network when an image of a different style is to be generated, improving the processing efficiency. Furthermore, image blocks are generated according to the mask of the target object and the background mask, respectively and then fused together, facilitating the replacement of the target object. In addition, due to factors such as the lamination, each image block (including the first partial image block and the background image block) may not have exactly the same style. For example, due to different lamination, each target object has a style slight different from the others. By generating each of the first partial image block and the background image block separately, the style of each image block is remained so that the first partial image block and the background image block are more harmonious.

FIG. 5 is an application schematic diagram of the image processing method according to an embodiment of the present disclosure. As shown in FIG. 5, the target image having the target style may be obtained by the image generation network and the fusion network.

In a possible implementation, semantic segmentation may be performed on any image to be processed to obtain a first semantic segmentation mask and a second semantic segmentation mask. Alternatively, the first semantic segmentation mask and the second semantic segmentation mask may be generated randomly. The first semantic segmentation mask, the second semantic segmentation mask and the first image having the target style and any content into the image generation network. The image generation network may output the first partial image block having the contour of the target object marked by the first semantic segmentation mask and having the target style of the first image according to the first semantic segmentation mask and the first image, and generate the background image block having the contour of the background marked by the second semantic segmentation mask and having the target style of the first image according to the first image and the second semantic segmentation mask. In an example, there may be more than one of the first partial image block. In other words, there may be more than one target object. The target object may of different types. For example, the target object may include person, motor vehicle, non-motor vehicle, etc. The style of the first image may be the styles of daytime, nighttime, rainy, etc. The present disclosure does not limit the style of the first image and does not limit the number of the first partial image block.

In an example, the first image may be an image having a nighttime background. The first semantic segmentation mask is a semantic segmentation mask of a vehicle, having a contour of the vehicle. The first semantic segmentation mask may also be semantic segmentation mask of a pedestrian and have a contour of the pedestrian. The second semantic segmentation mask is a semantic segmentation mask of a background. In addition, the second semantic segmentation mask may also indicate the location of the target object in the background. For example, the location of the pedestrian or vehicle in the second semantic segmentation mask is vacant. By the processing by the image generation network, the background, the vehicle and the pedestrian of the nighttime style can be generated. For example, the background has low lamination, and the vehicle and the pedestrian also have the style of a dark environment indicated by low lamination, blurred appearance, and the like.

In a possible implementation, during the generation, the size of the contour of the target object may alter. When the size of the first partial image block and the size of the vacant area in the background image block (i.e., the area in which the target object is located in the background image block) do not match, the first partial image block may be scaled to obtain the second partial image block of which the size matching the size of the area in which the target object is located (i.e., the vacant area) in the background image block.

In an example, there may be more than one semantic segmentation mask of vehicle, the contours may be identical or different. But in the second semantic segmentation mask, the different vehicles may be located in different positions and have different size. Hence, the image blocks of vehicles may be scaled such that the size of the image block of the vehicle and/or the pedestrian (i.e., the first partial image block) match the size of the vacant area in the background image block.

In a possible implementation, the second partial image block and the background image block may be spliced. For example, the second partial image block may be added to the area in which the target object is located in the background image block, thereby obtaining the target image formed by splicing. Since the area in which the target object is located (i.e., the second partial image block) and the background area (i.e., the background image block) in the target image are spliced together, the edge between the areas may be not smooth enough. For example, the edge between the image block of the vehicle and the background may be not smooth enough.

In a possible implementation, the area in which the target object is located and the background area in the target image are fused by a fusion network. For example, smoothing by Gaussian filter may be performed on the pixels in the vicinity of the edge such that the edge between the area in which the target object is located and the background area is smooth. Further, the area in which the target object is located and the background area may be subjected to style fusion. For example, the style of the area in which the target object is located and the background area, such as brightness, contrast ratio, illumination, color, artistic characteristics or graphic design, etc., may be slightly adjusted such that the area in which the target object is located and the background area have consistent and harmonious style, to obtain a smoothed target image having the target style. In an example, the vehicles are located in different positions in the background and have different size, and thus have different styles. For example, when irradiated by a street lamp, the brightness in the area of each vehicle differs, and the vehicles differentiate in light reflection. The fusion network adjusts the styles of the vehicles such that each vehicle and the background have harmonious style.

In a possible implementation, the image processing method of the present disclosure is capable of obtaining a target image by a semantic segmentation mask, thereby expanding the richness of image samples having a style consistent with the first image. In particular, for difficult image samples (e.g. images captured under rare weather conditions such as in an extreme weather) or rare image samples (e.g. images captured in capturing rare environments, such as images captured at night), the labor cost for collecting the image samples is greatly reduced. In an example, the image processing method may be implemented in the field of autopilot. With only the semantic segmentation mask and images of any style, a target image of having higher authenticity can be generated. The instance-level target object in the target image has a higher authenticity, which helps expand the application scenario of autopilot using the target image and thus contributes to the development of autopilot technology. The present disclosure does not limit the application area of the image processing method.

It is appreciated that the afore-mentioned method embodiments of the present disclosure may be combined with one another to form a combined embodiment without departing from the principle and the logics, which, due to limited space, will not be repeatedly described in the present disclosure.

In addition, the present disclosure further provides an image processing device, an electronic apparatus, a computer readable medium and a program which are all capable of realizing any image processing method provided by the present disclosure. The corresponding technical solution and description will not be repeated; reference may be made to the corresponding description of the method.

A person skilled in the art understands that the order of description of the steps in the afore-described methods according to the embodiments does not mean a strict order of execution of the steps or impose any limitation to the implementation of the method. The specific order of execution of the steps should be determined by the functions and possible inherent logics of the steps.

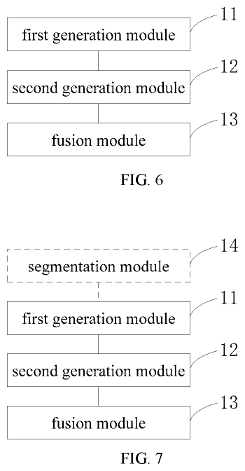

FIG. 6 is a block diagram of the image processing device according to an embodiment of the present disclosure. As shown in FIG. 6, the device comprises:

a first generation module 11 configured to generate at least one first partial image block according to a first image and at least one first semantic segmentation mask, wherein the first image is an image having a target style, the first semantic segmentation mask is a semantic segmentation mask showing an area in which a target object of one type is located, the first partial image block includes a target object of one type having the target style,

a second generation module 12 configured to generate a background image block according to the first image and a second semantic segmentation mask, wherein the second semantic segmentation mask is a semantic segmentation mask showing a background area other than the area in which at least one target object is located, the background image block includes a background having the target style,

a fusion module 13 configured to fuse at least one first partial image block and the background image block to obtain a target image, wherein the target image includes a target object having the target style and a background having the target style.

In a possible implementation, the fusion module is configured further to scale each first partial image block, obtain a second partial image block having a matching size when splicing with the background image block,

splice at least one second partial image block and the background image block, obtain the target image.

In a possible implementation, the background image block is an image that the background area includes a background having the target style and the area in which the target object is located is vacant,

wherein the fusion module is configured further to splice the at least one second partial image block and the background image block, obtain the target image comprises:

adding at least one second partial image block to a corresponding area in which the target object is located in the background image block to obtain the target image.

In a possible implementation, the fusion module is configured further to after splicing at least one second partial image block and the background image block and before obtaining the target image, smooth an edge between at least one second partial image block and the background image block, obtain the second image,

fuse styles of an area in which the target object is located in the second sample image and a background area, obtain the target image.

FIG. 7 is a block diagram of the image processing device according to an embodiment of the present disclosure. As shown in FIG. 7, the device further comprises:

a segmentation module 14 configured to perform a semantic segmentation on an image to be processed to obtain a first semantic segmentation mask and a second semantic segmentation mask.

In a possible implementation, functions of the first generation module and the second generation module are performed by an image generation network,

the device further comprises a training module, the training module configured to train the image generation network using steps of:

generating an image block according to a first sample image and a semantic segmentation sample mask by an image generation network to be trained,

wherein the first sample image is a sample image having a random style, the semantic segmentation sample mask is a semantic segmentation mask showing an area in which the target object is located in the second sample image or is a semantic segmentation mask showing an area other than the area in which the target object is located in the second sample image, when the semantic segmentation sample mask is a semantic segmentation sample mask showing an area in which the target object is located in the second sample image, the image block generated includes a target object having the target style, when the semantic sample segmentation mask is a semantic sample segmentation mask showing an area other than the area in which the target object is located in the second sample image, the image block generated includes a background having the target style,

determining a loss function of the image generation network to be trained according to the image block generated, the first sample image and the second sample image,

adjusting a network parameter value of the image generation network to be trained according to the loss function determined,

identifying authenticity of a portion to be identified in an input image by an image discriminator to be trained by using the image block generated or the second sample image as the input image, wherein, when the image block generated includes a target object having the target style, the portion to be identified in the input image is the target object in the input image, when the image block generated includes a background having the target style, the portion to be identified in the input image is the background in the input image,

adjusting the network parameter value of the image discriminator to be trained according to the output result of the image discriminator to be trained and the input image;

repeatedly executing the above steps by using the image generation network of which the network parameter value is adjusted as an image generation network to be trained, using an image discriminator of which the network parameter value is adjusted as the image discriminator to be trained, until a training termination condition of the image generation network to be trained and a training termination condition of the image discriminator to be trained reach a balance.

In some embodiments, the functions or modules included in the device provided in the embodiments of the present disclosure may be configured to execute the methods described in the above embodiments. The specific implementation may refer to the description of the embodiments of the method and will not be described repetitively to be concise.

The embodiments of the present disclosure also propose a computer-readable storage medium which stores computer program instructions, the computer program instructions implementing the afore-described method when executed by a processor. The computer-readable storage medium may be a non-volatile computer-readable storage medium.

The embodiments of the present disclosure also propose an electronic device, comprising: a processor; a memory for storing processor executable instructions, wherein the processor is configured to execute the above method.

The electronic apparatus may be provided as a terminal, a server or an apparatus in other form.

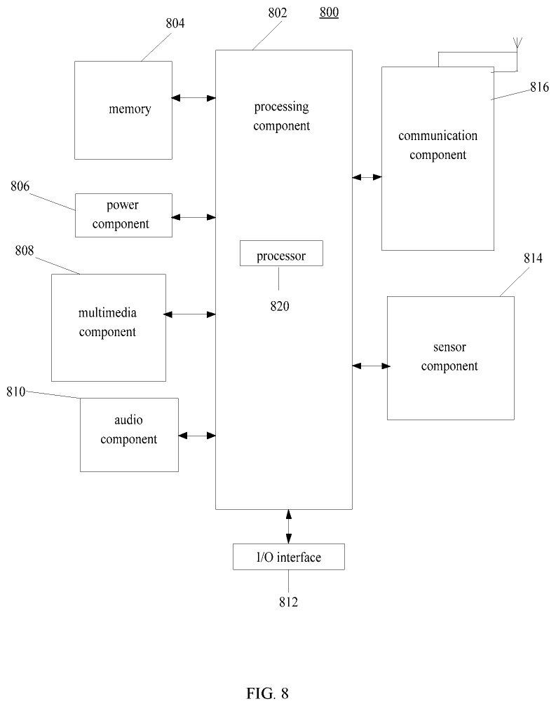

FIG. 8 is a block diagram showing an electronic apparatus 800 according to an embodiment of the present disclosure. For example, the electronic apparatus 800 may be a terminal such as a mobile phone, a computer, a digital broadcasting terminal, a messaging device, a game console, a tablet device, medical equipment, fitness equipment, a personal digital assistant and the like.

Referring to FIG. 8, electronic apparatus 800 may include one or more of the following components: a processing component 802, a memory 804, a power component 806, a multimedia component 808, an audio component 810, an input/output (I/O) interface 812, a sensor component 814, and a communication component 816.

Processing component 802 generally controls overall operations of electronic apparatus 800, such as the operations associated with display, telephone calls, data communications, camera operations, and recording operations. Processing component 802 can include one or more processors 1020 configured to execute instructions to perform all or part of the steps included in the above-described methods. Furthermore, processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic apparatus 800. Examples of such data include instructions for any applications or methods operated on or performed by electronic apparatus 800, contact data, phonebook data, messages, pictures, video, etc. Memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 provides power to various components of electronic apparatus 800. Power component 806 may include a power management system, one or more power sources, and any other components associated with the generation, management, and distribution of power in electronic apparatus 800.

Multimedia component 808 includes a screen providing an output interface between electronic apparatus 800 and the user. In some embodiments, the screen may include a liquid crystal display and a touch panel. If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, multimedia component 808 may include a front camera and/or a rear camera. The front camera and the rear camera may receive an external multimedia datum while electronic apparatus 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 include a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 includes one or more sensors configured to provide status assessments of various aspects of electronic apparatus 800. For example, sensor component 814 may detect at least one of an open/closed status of electronic apparatus 800, relative positioning of components, e.g., the display and the keypad, of electronic apparatus 800, a change in position of electronic apparatus 800 or a component of electronic apparatus 800, a presence or absence of user contact with electronic apparatus 800, an orientation or an acceleration/deceleration of electronic apparatus 800, and a change in temperature of electronic apparatus 800. Sensor component 814 may include a proximity sensor configured to detect the presence of nearby objects without any physical contact. Sensor component 814 may also include a light sensor, such as a CMOS or CCD image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic apparatus 800 and other devices. Electronic apparatus 800 can access a wireless network based on a communication standard, such as WiFi, 2G, or 3G, 4G, or a combination thereof. In exemplary embodiments, communication component 816 receives a broadcast signal or broadcast associated information from an external broadcast management system via a broadcast channel. In exemplary embodiments, the communication component 816 may also include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium, such as memory 804 including computer program instructions, which is executable by processor 820 of electronic apparatus 800, for performing the above-described methods.

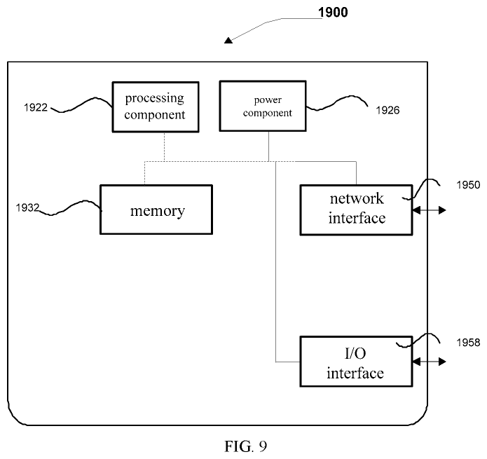

FIG. 9 is a block diagram showing an electronic apparatus 1900. For example, the electronic apparatus 1900 may be provided as a server. Referring to FIG. 9, the electronic apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the abovementioned methods.

The electronic apparatus 1900 may further include a power component 1926 configured to execute power management of the electronic apparatus 1900, a wired or wireless network interface 1950 configured to connect the electronic apparatus 1900 to a network, an Input/Output (I/O) interface 1958. The electronic apparatus 1900 may be operated on the basis of an operating system stored in the memory 1932, such as Window Server™, Mac OS X™, Unix™, Linux™ or Free BSD™.

In an exemplary embodiment, there is also provided a non-transitory computer readable storage medium including instructions, such as memory 1932 including computer program instructions, which is executable by processing component 1922 of apparatus 1900, for performing the above-described methods.

The present disclosure may be a system, a method, and/or a computer program product. The computer program product may include a computer readable storage medium having computer readable program instructions for causing a processor to carry out each aspect of the present disclosure.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
generating at least one first partial image block according to a first image and at least one first semantic segmentation mask, wherein the first image is an image having a target style, the first semantic segmentation mask is a semantic segmentation mask showing an area in which a target object of one type is located, the first partial image block includes the target object of one type having the target style;
generating a background image block according to the first image and a second semantic segmentation mask, wherein the second semantic segmentation mask is a semantic segmentation mask showing a background area other than the area in which at least one target object is located, the background image block includes a background having the target style; and
fusing the at least one first partial image block and the background image block to obtain a target image, wherein the target image includes the target object having the target style and the background having the target style.

2. The method of claim 1, wherein fusing the at least one first partial image block and the background image block to obtain the target image comprises:
scaling each of the first partial image block to obtain a second partial image block having a matching size when splicing with the background image block; and
splicing at least one second partial image block and the background image block to obtain the target image.

3. The method of claim 2, the background image block is an image that the background area includes a background having the target style and an area in which the target object is located is vacant,
splicing the at least one second partial image block and the background image block to obtain the target image comprises:
adding the at least one second partial image block to a corresponding area in which the target object is located in the background image block to obtain the target image.

4. The method of claim 2, after splicing the at least one second partial image block and the background image block and before obtaining the target image, the method further comprises:
smoothing an edge between the at least one second partial image block and the background image block to obtain a second image; and
fusing styles of the area in which the target object is located and the background area in the second image to obtain the target image.

5. The method of claim 3, after splicing the at least one second partial image block and the background image block and before obtaining the target image, the method further comprises:
smoothing an edge between the at least one second partial image block and the background image block to obtain a second image; and
fusing styles of the area in which the target object is located and the background area in the second image to obtain the target image.

6. The method of claim 1, the method further comprises:
performing a semantic segmentation on an image to be processed to obtain the first semantic segmentation mask and the second semantic segmentation mask.

7. The method of claim 1, wherein generating the at least one first partial image block according to the first image and the at least one first semantic segmentation mask and generating the background image block according to the first image and the second semantic segmentation mask are performed by an image generation network,
the image generation network is trained using steps of:
generating an image block according to a first sample image and a semantic segmentation sample mask by an image generation network to be trained,
wherein, the first sample image is a sample image having a random style, the semantic segmentation sample mask is a semantic segmentation sample mask showing an area in which the target object is located in a second sample image or is a semantic segmentation sample mask showing an area other than the area in which the target object is located in the second sample image,
when the semantic segmentation sample mask is the semantic segmentation sample mask showing an area in which the target object is located in the second sample image, the generated image block includes a target object having the target style, and
when the semantic segmentation sample mask is the semantic segmentation sample mask showing an area other than the area in which the target object is located in the second sample image, the generated image block includes a background having the target style;
determining a loss function of the image generation network to be trained according to the generated image block, the first sample image and the second sample image;
adjusting a network parameter value of the image generation network to be trained according to the determined loss function;
identifying authenticity of a portion to be identified in a input image by an image discriminator to be trained by using the generated image block or the second sample image as the input image, wherein, when the generated image block includes the target object having the target style, the portion to be identified in the input image is the target object in the input image, and when the generated image block includes the background having the target style, the portion to be identified in the input image is the background in the input image;
adjusting the network parameter value of the image discriminator to be trained and the network parameter value of the image generation network to be trained according to an output result of the image discriminator to be trained and the input image; and
repeatedly executing the above steps by using the image generation network of which the network parameter value is adjusted as the image generation network to be trained and using the image discriminator of which the network parameter value is adjusted as the image discriminator to be trained, until a training termination condition of the image generation network to be trained and a training termination condition of the image discriminator to be trained reach a balance.

8. An image processing device, comprising:
a processor; and
a memory configured to store processor-executable instructions,
wherein the processor is configured to invoke the instructions stored in the memory, so as to:
generate at least one first partial image block according to a first image and at least one first semantic segmentation mask, wherein the first image is an image having a target style, the first semantic segmentation mask is a semantic segmentation mask showing an area in which a target object of one type is located, the first partial image block includes the target object of one type having the target style;
generate a background image block according to the first image and a second semantic segmentation mask, wherein the second semantic segmentation mask is a semantic segmentation mask showing a background area other than the area in which at least one target object is located, the background image block includes a background having the target style; and
fuse the at least one first partial image block and the background image block to obtain a target image, wherein the target image includes the target object having the target style and the background having the target style.

9. The device of claim 8, wherein fusing the at least one first partial image block and the background image block to obtain the target image comprises:
scale each first partial image block to obtain a second partial image block having a matching size when splicing with the background image block; and
splice the at least one second partial image block and the background image block to obtain the target image.

10. The device of claim 9, the background image block is an image that the background area includes a background having the target style and an area in which the target object is located is vacant,
wherein fusing the at least one first partial image block and the background image block to obtain the target image comprises:
splice the at least one second partial image block and the background image block to obtain the target image comprises:
adding the at least one second partial image block to a corresponding area in which the target object is located in the background image block to obtain the target image.

11. The device of claim 9, fusing the at least one first partial image block and the background image block to obtain the target image comprises:
after splicing the at least one second partial image block and the background image block and before obtaining the target image, smooth an edge between the at least one second partial image block and the background image block to obtain a second image; and
fuse styles of the area in which the target object is located and the background area in the second image to obtain the target image.

12. The device of claim 10, fusing the at least one first partial image block and the background image block to obtain the target image comprises:
after splicing the at least one second partial image block and the background image block and before obtaining the target image, smooth an edge between the at least one second partial image block and the background image block to obtain a second image; and
fuse styles of the area in which the target object is located and the background area in the second image to obtain the target image.

13. The device of claim 8, the processor is further configured to invoke the instructions stored in the memory, so as to
perform a semantic segmentation on an image to be processed to obtain the first semantic segmentation mask and the second semantic segmentation mask.

14. The device of claim 8, wherein generating the at least one first partial image block according to the first image and the at least one first semantic segmentation mask and generating the background image block according to the first image and the second semantic segmentation mask are performed by an image generation network,
the image generation network is trained using steps of:
generating an image block according to a first sample image and a semantic segmentation sample mask by an image generation network to be trained,
wherein, the first sample image is a sample image having a random style, the semantic segmentation sample mask is a semantic segmentation sample mask showing an area in which the target object is located in the second sample image or is a semantic segmentation sample mask showing an area other than the area in which the target object is located in the second sample image, when the semantic segmentation sample mask is the semantic segmentation sample mask showing an area in which the target object is located in the second sample image, the generated image block includes a target object having the target style, when the semantic segmentation sample mask is the semantic segmentation sample mask showing an area other than the area in which the target object is located in the second sample image, the generated image block includes a background having the target style;
determining a loss function of the image generation network to be trained according to the generated image block, the first sample image and the second sample image;
adjusting a network parameter value of the image generation network to be trained according to the determined loss function;
identifying authenticity of a portion to be identified in a input image by an image discriminator to be trained by using the generated image block or the second sample image as the input image, wherein, when the generated image block includes the target object having the target style, the portion to be identified in the input image is the target object in the input image, and when the generated image block includes the background having the target style, the portion to be identified in the input image is the background in the input image;
adjusting the network parameter value of the image discriminator to be trained and the network parameter value of the image generation network to be trained according to an output result of the image discriminator to be trained and the input image; and
repeatedly executing the above steps by using the image generation network of which the network parameter value is adjusted as an image generation network to be trained and using the image discriminator of which the network parameter value is adjusted as the image discriminator to be trained, until a training termination condition of the image generation network to be trained and a training termination condition of the image discriminator to be trained reach a balance.

15. A non-transitory computer readable storage medium that stores computer program instructions, when the computer program instructions are executed by a processor, the processor is caused to perform the operations of:
generating at least one first partial image block according to a first image and at least one first semantic segmentation mask, wherein the first image is an image having a target style, the first semantic segmentation mask is a semantic segmentation mask showing an area in which a target object of one type is located, the first partial image block includes the target object of one type having the target style;
generating a background image block according to the first image and a second semantic segmentation mask, wherein the second semantic segmentation mask is a semantic segmentation mask showing a background area other than the area in which at least one target object is located, the background image block includes a background having the target style; and
fusing the at least one first partial image block and the background image block to obtain a target image, wherein the target image includes the target object having the target style and the background having the target style.

16. The non-transitory computer readable storage medium of claim 15, wherein fusing the at least one first partial image block and the background image block to obtain the target image comprises:
scaling each of the first partial image block to obtain a second partial image block having a matching size when splicing with the background image block; and
splicing at least one second partial image block and the background image block to obtain the target image.

17. The non-transitory computer readable storage medium of claim 16, the background image block is an image that the background area includes a background having the target style and an area in which the target object is located is vacant,
splicing the at least one second partial image block and the background image block to obtain the target image comprises:
adding the at least one second partial image block to a corresponding area in which the target object is located in the background image block to obtain the target image.

18. The non-transitory computer readable storage medium of claim 16, after splicing the at least one second partial image block and the background image block and before obtaining the target image, the processor is further caused to perform the operations of:
smoothing an edge between the at least one second partial image block and the background image block to obtain a second image; and
fusing styles of the area in which the target object is located and the background area in the second image to obtain the target image.

19. The non-transitory computer readable storage medium of claim 17, after splicing the at least one second partial image block and the background image block and before obtaining the target image, the processor is further caused to perform the operations of:
smoothing an edge between the at least one second partial image block and the background image block to obtain a second image; and
fusing styles of the area in which the target object is located and the background area in the second image to obtain the target image.

20. The non-transitory computer readable storage medium of claim 15, wherein generating the at least one first partial image block according to the first image and the at least one first semantic segmentation mask and generating the background image block according to the first image and the second semantic segmentation mask are performed by an image generation network,
the image generation network is trained using steps of:
generating an image block according to a first sample image and a semantic segmentation sample mask by an image generation network to be trained,
wherein, the first sample image is a sample image having a random style, the semantic segmentation sample mask is a semantic segmentation sample mask showing an area in which the target object is located in a second sample image or is a semantic segmentation sample mask showing an area other than the area in which the target object is located in the second sample image,
when the semantic segmentation sample mask is the semantic segmentation sample mask showing an area in which the target object is located in the second sample image, the generated image block includes a target object having the target style, and
when the semantic segmentation sample mask is the semantic segmentation sample mask showing an area other than the area in which the target object is located in the second sample image, the generated image block includes a background having the target style;
determining a loss function of the image generation network to be trained according to the generated image block, the first sample image and the second sample image;
adjusting a network parameter value of the image generation network to be trained according to the determined loss function;
identifying authenticity of a portion to be identified in a input image by an image discriminator to be trained by using the generated image block or the second sample image as the input image, wherein, when the generated image block includes the target object having the target style, the portion to be identified in the input image is the target object in the input image, and when the generated image block includes the background having the target style, the portion to be identified in the input image is the background in the input image;
adjusting the network parameter value of the image discriminator to be trained and the network parameter value of the image generation network to be trained according to an output result of the image discriminator to be trained and the input image; and
repeatedly executing the above steps by using the image generation network of which the network parameter value is adjusted as the image generation network to be trained and using the image discriminator of which the network parameter value is adjusted as the image discriminator to be trained, until a training termination condition of the image generation network to be trained and a training termination condition of the image discriminator to be trained reach a balance.
